(19) United States
(12) Patent Application Publication
(10) Pub. No.: US 2006/0263103 A1
(43) Pub. Date: Nov. 23, 2006

(54) Method and apparatus for inducing substrate transport faults in image forming machines

(75) Inventors: Douglas Bisset, Stevenage (GB); Martin Walsh, St. Albans (GB); Annmarie Brinsley, Stevenage (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: XEROX CORPORATION

(21) Appl. No.: 11/134,963

(22) Filed: May 23, 2005

(51) Int. Cl. G03G 15/00

(52) U.S. Cl. 399/16

(57) ABSTRACT

A method of inducing a substrate transport fault in an image forming apparatus having a substrate transport assembly includes prompting a user to provide one or more substrate transport fault conditions, starting an image forming job, and inducing a substrate transport fault during the image forming job in accordance with the one or more fault conditions. An image forming machine is described having a substrate transport assembly for moving substrate sheets through the image forming apparatus for forming images thereon, a User Interface for prompting a user to provide one or more substrate transport fault conditions, and a controller for inducing a substrate transport fault in the image forming apparatus in accordance with the one or more substrate transport fault conditions.

### BACKGROUND

The embodiments described herein relate generally to image forming machines such as copiers and/or printers and, more particularly, concern a method and apparatus for deliberately inducing substrate transport faults in these machines.

In image forming machines, such as copiers and printers, one or more images are formed on substrates, such as paper. For example, devices such as electrophotographic copiers bring the substrate into contact with a photoconductive member (or photoreceptor) and the toner materials are transferred to it by electrostatic charging. The substrate is subsequently heated for permanent bonding of the reproduced image, thus producing a hard copy reproduction of the original document or image. Other image forming devices may form the images in different manners, but all use a substrate transport assembly to move the substrate through the machine during an image forming job.

Various sizes of substrates are typically stored in separate trays that are mounted in or on the machine. During the image forming job, a substrate transport assembly moves a substrate with the appropriate dimensions from the appropriate tray into a paper path through the machine. The substrate transport assembly moves the substrate along the paper path, through an image forming assembly and out of the machine after the image is formed on it. The substrate transport assembly can include an inverting device for inverting the substrate to form an image on the opposite side. Post processing may be performed on the substrate sheets afterwards which can include collating, sorting, stapling, etc.

Paper movers such as rollers, also referred to as nips, are typically used in the substrate transport assembly for moving the substrate through the machine. Sensors are also used by the substrate transport assembly to control the movement of the substrate sheets and insure the proper timing, spacing, and orientation of the sheets at the various points in the image forming machine. Furthermore, the substrate transport assembly must be able to accommodate a wide range of substrates having a variety different sizes, thickness, and other qualities. As a result of these varied and complex duties, the paper transport assembly has increased in complexity through the years.

When substrate transport faults, also known as paper jams, occur in the transport assembly the machine is typically programmed to shut down during the image forming job and notify the operator that a fault has occurred, and oftentimes how to clear it. One reference, U.S. Pat. No. 6,560,415 B2 to Hirako et al which is hereby incorporated by reference herein, teaches how the image forming machine induces a fault in the paper transport assembly in response to a fault occurring downstream in the post processing portion of the substrate transport assembly. However, this reference only describes inducing a fault after the occurrence of, and in response to, a prior occurring substrate transport fault.

As the substrate transport assembly becomes more and more sophisticated and complicated, a need has arisen for helping operators learn more about substrate transport faults such as where they occur and how to clear them. Accordingly, it has been considered desirable to develop a system and method which meet these needs.

### SUMMARY

In accordance with one aspect of the embodiments described herein, there is provided a method of deliberately inducing a substrate transport fault in an image forming apparatus having a substrate transport assembly. The method includes prompting a user to provide one or more substrate transport fault conditions, starting an image forming job, and inducing a substrate transport fault during the image forming job in accordance with the one or more fault conditions.

In accordance with a second aspect of the invention, an image forming machine having a substrate transport fault inducing training feature is described herein. The image forming machine includes a substrate transport assembly for moving substrate sheets through the image forming machine for forming images thereon, a User Interface for prompting a user to provide one or more substrate transport fault conditions, and a controller for inducing a substrate transport fault in the image forming apparatus in accordance with the one or more substrate transport fault conditions.

### BRIEF DESCRIPTION OF THE DRAWINGS

The foregoing and other features of the exemplary embodiment will be apparent and easily understood from a further reading of the specification, claims, and by reference to the accompanying drawings in which:

FIG. 1 is a diagrammatic view of an electrophotographic reproduction image forming machine incorporating a substrate transport fault inducing training feature;

FIG. 2 is a flow chart illustrating a method for deliberately inducing a substrate transport fault in accordance with user provide transport fault conditions;

FIG. 3 is a diagrammatic view of an electrophotographic reproduction image forming machine illustrating a substrate transport fault induced in accordance with user provided fault conditions; and

FIG. 4 is a diagrammatic view of the electrophotographic reproduction image forming machine illustrating another substrate transport fault induced in accordance with user provided fault conditions.

### DETAILED DESCRIPTION OF THE EXEMPLARY EMBODIMENT

The present application is directed to a method and apparatus for deliberately inducing substrate transport faults in an image forming machine, or apparatus, in accordance with one or more user provided substrate transport fault conditions. The substrate transport faults described herein are also known as paper jams. These faults can include instances of the substrate, such as paper, being jammed in the paper path of the image forming machine, or instances of events which are expected to occur in the transport assembly but don't, thereby signaling the occurrence of a fault. After the substrate transport fault is induced, the image forming machine is stopped in the middle of the image forming job and the user can be provided with fault, or jam clearance information indicating how the jam can be cleared so as to return the image forming machine to normal operating conditions.

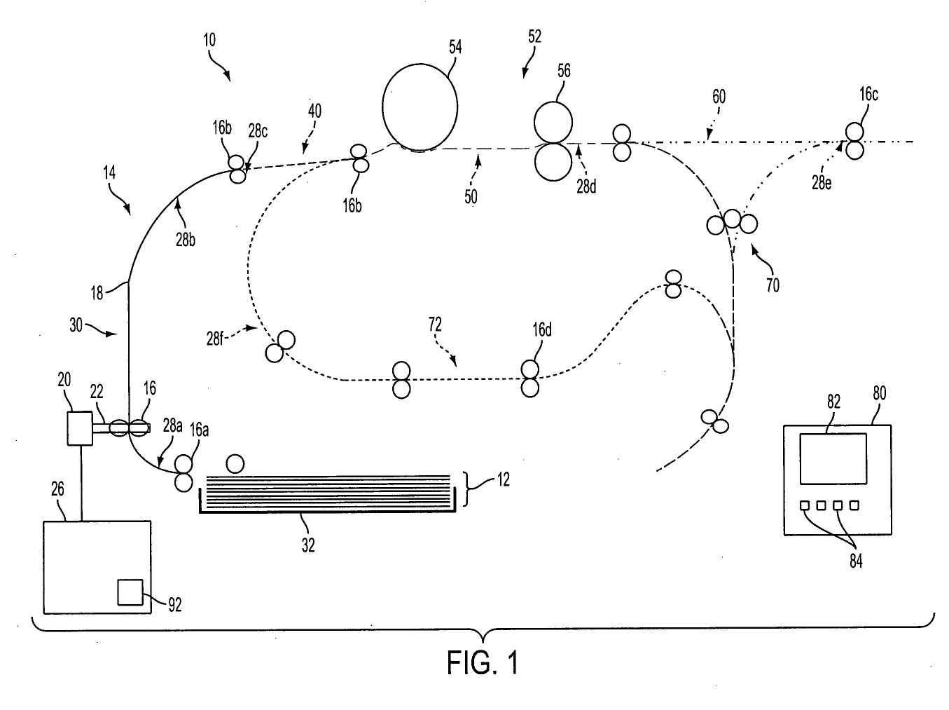

Referring now to the drawings, FIG. 1 is a schematic depiction of the various components of an example of an image forming machine in the form of a xerographic or electrophotgraphic copying machine 10 for forming an image on a substrate sheet 12. The substrate 12 can be paper, a transparency or other materials suitable for forming an image thereon. The image forming machine 10 described herein is provided for the purposes of example and should not be considered limiting. It should be appreciated that the system and method of inducing a substrate transport fault described herein can be applicable to other image forming machines, including but not limited to copiers, printers, and multifunction machines using a substrate transport assembly when forming an image on a substrate.

The image forming machine 10 includes a substrate transport assembly 14 for moving the substrate 12 through the machine 10 when forming the image thereon. The substrate transport assembly 14 includes sheet movers referred to generally at 16. Examples of suitable sheet movers can include, but are not limited to, rotating rollers 16 for moving individual sheets of substrate 12 through the substrate transport assembly 14 along a path through the machine, referred to as the substrate path or the paper path 18. The sheet moving rollers 16 are rotated by motors, only one of which is shown at 20 for simplicity. The motors 20 can be stepper motors, three phase motors, brushless or direct current motors, among others. Clutches 22, only one of which is shown in FIG. 1 for simplicity, can be used to engage the rollers 16 with the motors 20 for turning in a known manner, or alternatively the rollers 16 can be directly coupled to the motors for turning.

A controller 26 controls the motors 20 and the engagements/disengagements of the clutches 22 for controlling the rotational speed and timing of the rollers 16 for accurately controlling the movement of the substrate sheets 12 through the machine 10. The controller 26 can be a microprocessor or one of other known computing machines, and it can control general machine functions as well as the substrate transport fault inducing features described herein.

The substrate transport assembly 14 can also include one or more sensors, referred to generally at 28, which are connected to the controller 26 for providing substrate information to the controller used in moving the substrate along the paper path 18 in a controlled manner. The substrate information can include, but is not limited to, substrate sheet counts, location information such as leading edge and trailing edge location information, substrate orientation information, substrate spacing, and substrate speed information, among others. The sensors 28 can be switches, optoelectronic sensors, and other suitable known sensors for providing the substrate information to the controller 26. Timers 92 can be used by the controller 26 for controlling the movement of the substrate sheets through the substrate transport assembly as described in further detail below.

The substrate transport assembly 14 can include a supply portion 30, the paper path of which is shown using a solid line, for separating and moving individual sheets of the substrate 12 from a substrate supply holder 32, an example of which can include, but is not limited to, a paper tray. In the examples provided herein, a single substrate supply holder 32 in the form of a single paper tray is shown for the purposes of simplification, however it should be appreciated that the image forming machine 10 can include a plurality of substrate supply holders, for holding different sizes and/or types of substrates 12 capable of having images formed thereon. The supply portion 30 of the substrate transport assembly 14 includes sheet mover rollers 16a controlled by the controller 26 for moving the substrate sheets 12 as described above. The supply portion 30 can also include a feed sensor 28a disposed near the substrate supply holder 32 for monitoring the feeding of individual sheets of substrate from the substrate supply holder. The feed sensor 28a can provide sensor information that can be used to determine the number and types of sheets of substrate that have entered the paper path 18. The supply portion 30 can also include a Wait Point Sensor 28b for providing sensor information used for halting sheets in the supply portion 30 for proper timing and spacing.

The substrate transport assembly 14 can also include a registration portion 40, the paper path of which is shown using a dashed line, for insuring that each sheet of substrate 12 is properly synchronized for entry into an image forming assembly 52 for forming the image thereon. The registration portion 40 can include registration rollers 16b and one or more registration sensors 28c connected to the controller 26, for controlling the speed, orientation and timing of the substrate sheets into the imaging assembly 52. The registration portion 40 typically intercepts the substrate and adjusts it's velocity using registration rollers 16b in order to effect proper synchronization with imaging elements in the imaging assembly 52. The registration portion 40 can also insure proper process orientation by correcting skew and lateral offset in the substrate sheets 12.

The substrate transport assembly 14 typically also includes an imaging portion 50, the paper path of which is shown using a dash-dot line, for moving the substrate 12 through the image forming assembly 52 where the image is formed on the substrate. The image forming assembly 52 can include a photoconductive member or photoreceptor 54. An electrostatic latent image of an original document being copied is formed on the surface of the photoreceptor 54 and a developer material including toner particles (not shown) is then brought into contact with the surface of the photoconductive member to transform the latent image into a visible reproduction. The substrate transport assembly imaging portion 50 brings a blank substrate into contact with the photoconductive member 54 and the toner materials are transferred to it by electrostatic charging of the substrate. The substrate 12 is subsequently heated in a fuser 56 for permanent bonding of the reproduced image, thus producing a hard copy reproduction of the original document or image. The image forming portion 50 of the substrate transport assembly 14 can include a post fuser sensor 28d disposed after the fuser 56 which provides substrate information to the controller 26 for controlling the movement of the substrate sheets through the image forming machine.

The substrate transport assembly 14 can also include an exit portion 60, the paper path of which is shown using a dash-dot-dot line, having exit rollers 16c connected to controller 26 for moving the substrate with the image formed thereon out of the image forming machine 10. The exit portion 60 can include an exit sensor 28e connected to the controller 26 for providing substrate information, such as location information indicating that a substrate sheet 12 is exiting the machine.

The image forming machine 10 can also include an inverting assembly 70, the paper path of which is shown using a long dashed line, for turning the substrate 12 over so that an image can be formed on the opposite side thereof. The substrate transport assembly 14 can also include a duplex portion 72, the paper path of which is shown using a dotted line. The duplex portion 72 includes rollers 16d connected to controller 26 for transporting the inverted substrate sheets back to the image forming assembly 52 for forming an image on the second side thereof. The duplex portion 72 can include a duplex registration sensor 28f connected to the controller 26 for providing substrate information used for synchronizing and orienting the substrate sheets in the duplex portion in a manner similar to the registration portion 40 described above.

The image forming machine 10 can provide different types of image forming jobs. These image forming jobs can include simplex non-inverting jobs in which images are formed on first sides of the substrate without inverting them, simplex inverting jobs in which images are formed on the second sides of the substrate after inverting them, and duplex jobs in which images are formed on first sides of the substrate, the substrate are inverted and then images are formed on the second sides of the substrate. The substrate transport assembly 14 is used for moving the substrate sheets 12 through the machine during each of these image forming jobs.

The image forming machine 10 includes a User Interface 80 connected to the controller 26 for enabling a user, also referred to as an operator, to select and control machine functions including the types of image forming jobs to be performed. The User Interface 80 enables the user to provide substrate transport fault conditions for deliberately inducing substrate transport faults as described below. The User Interface 80 includes a screen 82 for providing operation information and instructions to the user. The user can select and control a variety of machine functions via buttons 84, such as hardbuttons or softbuttons.

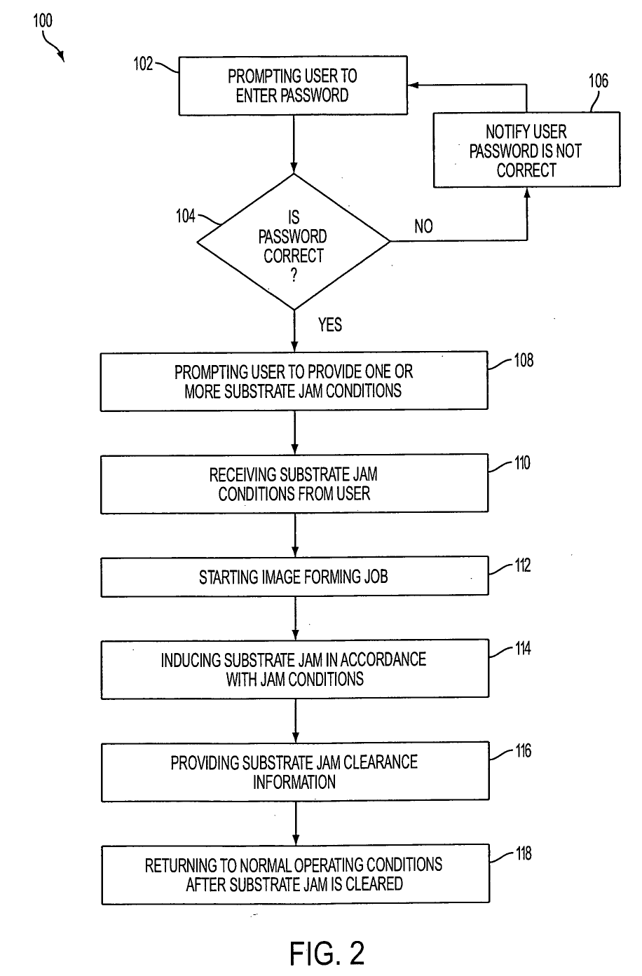

Referring now to FIG. 2, the operation of the substrate inducing features of the image forming machine 10 shall be described as a method, shown generally at 100, of deliberately inducing a substrate transport fault in the image forming machine 10 based on user provided substrate transport fault conditions. In order to initiate the substrate transport fault inducing feature, the user can be prompted to enter a password via the User Interface at 102. Using password protection will prevent unauthorized use of the substrate transport fault inducing feature, however it should be appreciated that password protection can be optional. If it is determined that the entered password is not correct at 104, the User Interface can notify the user that the password was incorrect and to re-enter a correct password at 106. If it is determined that the user entered a correct password at 104, the substrate transport fault inducing feature is initiated.

Next, the user is prompted to provide one or more substrate transport fault conditions at 108 via the User Interface 80. These substrate transport fault conditions can include, but are not limited to the type of fault the user wishes to induce. Some examples of the types of substrate transport faults the user can have the image forming machine 10 induce, as well as examples of how these faults are induced, are provided below. It is contemplated that most any type of substrate transport fault typically occurring in an image forming machine 10 can be recreated and deliberately induced by the system and method described herein. It should be appreciate that the controller 26 can be pre-programmed with ways to induce the faults that are selected by the user, if the user does not provide this information. Providing selections of the faults that can be induced, without asking the user to select how they will be induced can simplify the fault inducing features described herein.

Other substrate transport fault conditions provided by the user can also include the type of image forming job the image forming machine 10 will run during which the induced fault will occur. Examples of these types of jobs can include, but are not limited to simplex non-inverting, simplex inverting and duplex jobs, among others. Other substrate transport fault conditions provided by the user can also include the job length, that is the number of substrate sheets on which images are to be formed. For example, the user can select the job length to be ten sheets with images, also referred to as ten copies.

Another example of a substrate transport fault condition that can be provided by the user is the substrate sheet number on which the substrate transport fault is to occur. The user can select to have the fault induced on any sheet within the job. Providing the user with the ability to induce a substrate transport fault on a particular sheet in the image forming job enables the user to learn what happens to sheets that follow the fault sheet and how to clear the entire paper path when a substrate transport fault occurs. It should be appreciated that the controller 26 can be programmed to select a sheet number on which the jam is to occur if this information is not entered by the user.

After the substrate transport fault conditions are received at 110, the image forming machine starts the image forming job at 112. The controller 26 uses the sensors 28 to monitor the number and location of the substrate sheets 12 and induces the substrate transport fault in accordance with the one or more fault conditions entered by the user at 114 as described in further detail below. After the substrate transport fault is induced, the image forming machine 10 halts the image forming job and provides fault or jam clearance information to the user via the User Interface at 116. The jam clearance information can be known jam clearance information typically provided to a user after a substrate transport fault occurs. This information can include the location of the fault and instructions on how to clear the jam. If desired, more detailed explanations can be provided for training purposes. After the user has properly cleared the substrate transport fault, the image forming machine 10 returns to normal operating conditions. The user can be prompted to enter more substrate transport fault conditions for inducing another jam, or the jam inducing feature can exited.

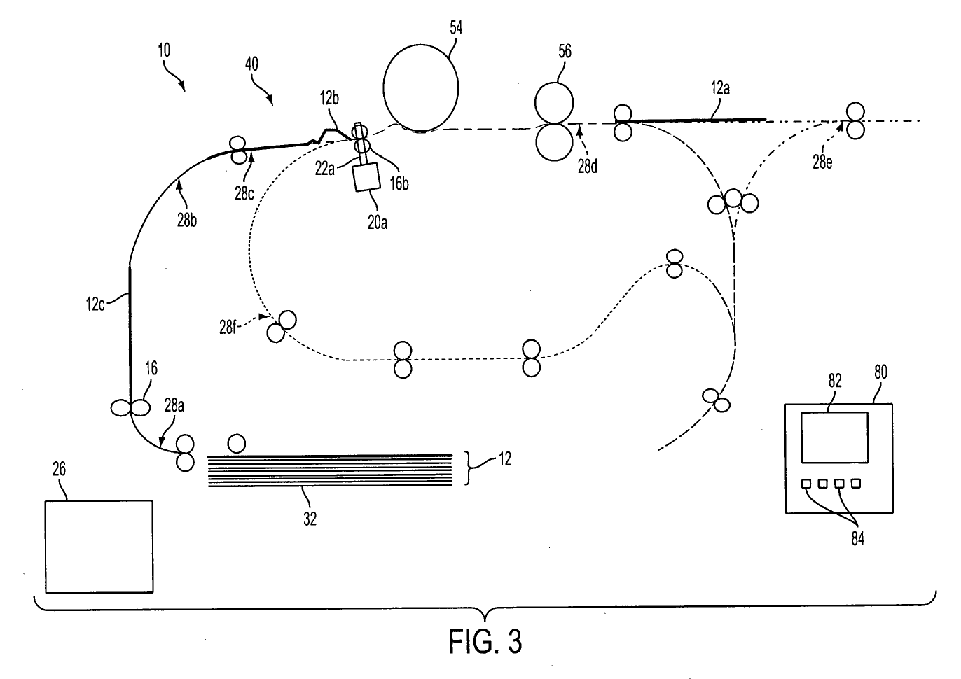

Referring now to FIG. 3, an example of an apparatus for inducing a substrate transport fault in accordance with user provided substrate transport fault conditions is illustrated. An image forming machine similar to the image forming machine described above is shown generally at 10. The user enters substrate transport fault conditions into the User Interface 80 when prompted for them at 108. The substrate transport fault conditions include directing the machine 10 to induce a substrate transport fault in the registration portion 40. The user may be provided with several options for selecting different kinds of substrate transport faults that can be induced in the registration portion as described above. Further, the user can be prompted with options for selecting how the selected substrate transport fault is to be induced. In this example, the user selects a substrate transport fault at the registration rollers 16c. Also, the user can provide other substrate transport fault conditions such as selecting the job length via the User Interface 80. In this example the job length is chosen to be 3 sheets. The user can provide other substrate transport fault conditions which include selecting the type of imaging job to be run. In this example, the job is chosen to be a simplex invert job in which the image is formed on the second side of the substrate sheet 12 after it is inverted in the inverting assembly 70. The user also provides substrate transport fault conditions which include having the controller 26 induce the substrate transport fault on the second sheet of substrate.

The image forming job is started at 112 and the first sheet of substrate 12a is transported through the machine 10 via the substrate transport assembly 14. The substrate transport assembly 14 continues to operate in it's normal operating, fault-free manner inverting the first substrate sheet 12a and moving it to the image forming assembly 52 where an image is formed on the second side. The substrate transport assembly 14 moves the second substrate sheet 12b through the machine 10 in a normal operating, fault-free manner until the controller 26 induces the substrate transport fault by not enabling the registration roller clutch 22b to turn the registration rollers 16b when the second substrate sheet reaches them so that the sheet gets jammed at the registration rollers as shown at 12b. In other examples, the roller can be disabled in other manners including not operating the motor responsible for turning it, etc. It should be appreciated that other substrate transport faults can be induced in other portions of the substrate transport assembly 14 by disabling other rollers including but not limited to the feed rollers 16a, image forming assembly rollers, exit rollers 16c, and duplex rollers 16d, among others.

The image forming job is the halted and jam clearance information is provided to the user via the User Interface 80 at 116 as described above. In this example, the jam clearance information can inform the user that a substrate transport fault has occurred at the registration rollers 16b and can inform the user how to open the machine and clear the jam at this location.

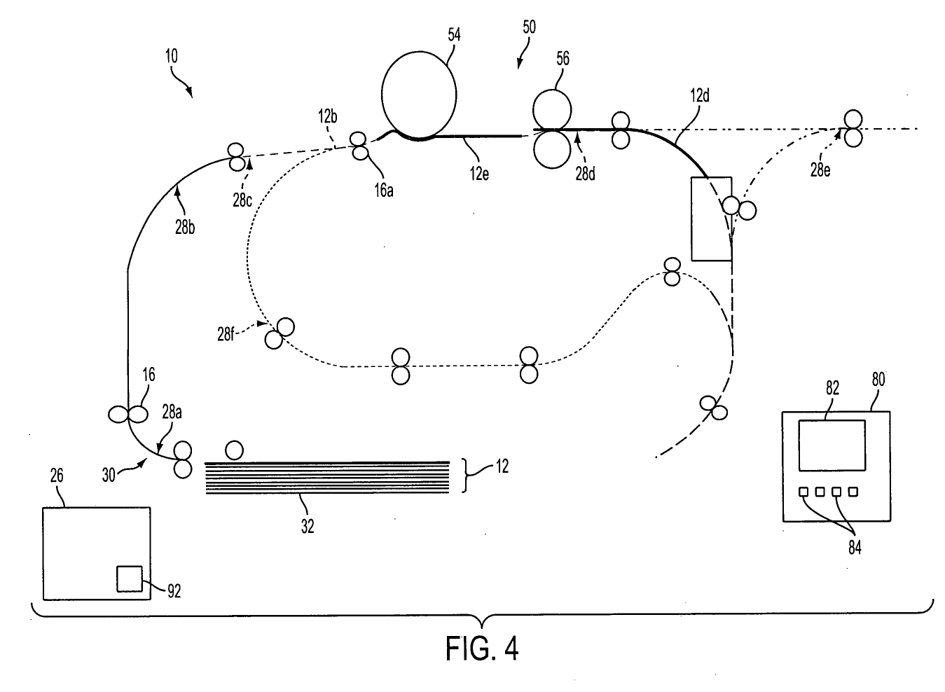

Referring now to FIG. 4, another example of inducing a substrate transport fault in accordance with user provided substrate transport fault conditions is illustrated in an image forming machine 10. The user enters substrate transport fault conditions into the User Interface 80 directing the machine 10 to run a simplex inverting image forming job having a length of two sheets, including a first sheet 12d and a second sheet 12e. The substrate transport fault conditions also include inducing a substrate transport fault on the first substrate sheet 12d in the image forming assembly portion 50. As described above, the user can select how the fault can be induced, or the controller can determine this. In this example, the fault is induced by ignoring substrate information provided by the post fuser sensor 28d. More specifically, the a timer 92 is started prior to the leading edge of the first substrate sheet 12d passing the post fuser sensor 28d. Under typical operating conditions, if this timer expires prior to the time the leading edge passes by the post fuser sensor 28d, which is provided as substrate information by the sensor to the controller 26, the controller interprets this as a substrate transport fault and shuts down the machine. In this example, the fault is induced by ignoring, that is to say, by not using the substrate information the post fuser sensor 28d provides to the controller 26 indicating the lead edge of sheet 12d has passed as expected, and as a result, the timer 92 expires and the controller 26 halts the image forming job. It should be appreciated that other substrate transport faults can be induced in other portions of the substrate transport assembly 14 by ignoring the substrate information provided by other sensors such as the feed sensor 28a, Wait Point Sensor 28b, registration sensors 28c, or exit sensors 28e, among others.

Jam clearance information is then provided to the user via the User Interface 80 at 116 as described above. In this example, the jam clearance information can inform the user that a substrate transport fault has occurred in the image forming assembly 50 and can inform the user how to open the machine and clear the jam at this location. The jam clearance information may also request that other sheets in the job, such as the second sheet be cleared by the operator. After the user clears the jam, the image forming machine 10 can revert back to it's normal operating mode, or it can prompt the user for more substrate fault conditions for inducing yet another paper jam.

The substrate transport faults illustrated herein are provided by way of example, and it should be appreciated that other substrate transport faults can be deliberately induced in similar manners. The deliberate inducement of substrate transport faults during otherwise fault-free image forming jobs can be performed as training exercises for operators of the image forming machine. Inducing the faults in accordance with the wide range of user provided substrate transport fault conditions describe above provides a thorough training experience that will educate users and prepare them for handling these faults while operating the machine on their own. Instructors, can use the training features to educate users in a supervised environment, or operators can be allowed to use the training feature on their own to learn about clearing such faults. The system and method described herein provides a valuable enhancement to most any image forming machine.

While particular embodiments have been described, alternatives, modifications, variations, improvements and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

What is claimed is:

1. A control method of an image forming apparatus having a substrate transport assembly comprising:
prompting a user to provide one or more substrate transport fault conditions;
starting an image forming job; and
inducing a substrate transport fault during the image forming job in accordance with the one or more fault conditions, wherein the substrate transport fault is the first substrate transport fault occurring in the image forming job.

2. The method defined in claim 1 wherein the one or more substrate transport fault conditions include at least one of the type of fault to be recreated, the type of image forming job to be performed, the job length, and the sheet number on which the fault is to occur.

3. The method defined in claim 1 further comprising providing fault clearance instructions after inducing the fault.

4. The method defined in claim 1 further comprising receiving a password from the user prior to inducing the fault.

5. The method defined in claim 1 wherein the substrate transport assembly includes a roller for moving the substrate and the inducing step further comprises disabling the roller so as not to rotate.

6. The method defined in claim 5 wherein the substrate transport assembly includes a clutch for engaging the roller with a motor for rotating the roller and the inducing step further comprises disabling the clutch.

7. The method defined in claim 1 wherein the substrate transport assembly includes a sensor providing substrate information for moving the substrate through the substrate transport assembly in a controlled manner and the inducing step further comprises ignoring the substrate information.

8. The method defined in claim 1 wherein the substrate transport assembly includes a sensor providing substrate information for moving the substrate through the substrate transport assembly in a controlled manner and the inducing step further comprises disabling the sensor.

9. An image forming apparatus having a substrate transport fault clearance training feature comprising:
a substrate transport assembly for moving substrate sheets through the image forming apparatus for forming images thereon;
a User Interface for prompting a user to provide one or more substrate transport fault conditions; and
a controller for inducing a substrate transport fault in the image forming apparatus in accordance with the one or more substrate transport fault conditions.

10. The image forming apparatus defined in claim 9 wherein the one or more substrate transport fault conditions include at least one of the type of fault to be recreated, the type of image forming job to be performed, the job length, and the sheet number on which the fault is to occur.

11. The image forming apparatus defined in claim 9 wherein the substrate transport assembly further comprises a supply portion and the controller induces the substrate fault in the supply portion.

12. The image forming apparatus defined in claim 9 wherein the substrate transport assembly further comprises a registration portion and the controller induces the substrate fault in the registration portion.

13. The image forming apparatus defined in claim 9 wherein the substrate transport assembly further comprises an image forming portion and the controller induces the substrate fault in the image forming portion.

14. The image forming apparatus defined in claim 9 wherein the substrate transport assembly further comprises an image forming portion and the controller induces the substrate fault in the image forming portion.

15. The image forming apparatus defined in claim 9 wherein the substrate transport assembly further comprises a roller for moving the substrate and the controller induces the substrate transport fault by disabling the roller.

16. The image forming apparatus defined in claim 15 wherein the substrate transport assembly further comprises a clutch for engaging the roller with a motor for rotating the roller and the controller induces the substrate transport fault by disabling the clutch.

17. The image forming apparatus defined in claim 9 wherein the substrate transport assembly includes a sensor providing substrate information to the controller for moving the substrate through the substrate transport assembly in a controlled manner and the controller induces the substrate transport fault by disabling the sensor.

18. The image forming apparatus defined in claim 9 wherein the substrate transport assembly includes a sensor providing substrate information to the controller for moving the substrate through the substrate transport assembly in a controlled manner and the controller induces the substrate transport fault by ignoring the substrate information.
